(19) United States
(12) Patent Application Publication
(10) Pub. No.: US 2006/0051513 A1
(43) Pub. Date: Mar. 9, 2006

(54) Multilayer coatings having color matched adhesion promoters

(76) Inventors: Michael L. Jackson, LaGrange, IL (US); Ruth Anita Jackson, Chicago, IL (US); Joseph M. Mecozzi, St. John, IN (US); Frank A. Stubbs, Dyer, IN (US); Peter J. Willman, Lake Orion, MI (US)

Correspondence Address: ROHM AND HAAS COMPANY;PATENT DEPARTMENT, 100 INDEPENDENCE MALL WEST, PHILADELPHIA, PA, 19106-2399, US

(21) Appl. No.: 11/205,603

(22) Filed: Aug. 17, 2005

Related U.S. Application Data
(60) Provisional application No. 60/606,980, filed on Sep. 3, 2004.

(51) Int. Cl. B05D 1/36

(52) U.S. Cl. 427/402

(57) ABSTRACT

The present invention provides coatings comprising a substrate coated with one or more than one colored primer layer comprising one or more than one binder chosen from a resinous or (co)polymeric primer or adhesion promoter, and one or more than one basecoat color layer thereon, wherein the color of each of the basecoat layer and the colored primer layer are the same. Preferred coatings comprise single colored primer and basecoat color layers to make color coatings having a reduced film build, i.e. two layers. Binders for making primer coating layers may comprise weatherable primer resins or (co)polymers, or may comprise adhesion promoters chosen from modified isotactic polypropylene (MPP), MPP copolymers, chlorinated polyolefin (CPO), and their mixtures with alkyds or acrylics. In addition, the present invention provides methods for making coatings on substrates such as thermoplastic polyolefin (TPO), polyolefin containing or metal substrates. Accordingly, the present invention provides color coatings that exhibit improved hiding of dark color or black substrates, such as automotive plastics like TPO, made from simplified coating methods.

### FIELD OF THE INVENTION

The present invention relates to waterborne or solventborne coatings in two or more than two layers, wherein the primer or adhesion promoter layer is color matched to the basecoat or color coat layer, and to coating methods of making the same. More particularly, the present invention relates to automotive coatings for plastic substrates, such as thermoplastic polyolefin (TPO), wherein the adhesion promoter layer is color matched to the basecoat layer.

### BACKGROUND OF THE INVENTION

Coating industrial, e.g. automotive, substrates requires at least two coating layers to derive the requisite color, coating adhesion and durability. Taking color for example, automotive plastic substrates, in particular, TPO substrates used for automobile bumpers and some interior parts, are black or dark gray in color. Further, such plastic substrates have been coated with primers which are black or dark gray in color. Likewise, automotive metallic substrates have been coated with primers which are light to dark gray or a muddy red or brown to taupe in color. As a result, the color of the adhesion promoter, primer or substrate layer can show through the basecoat or colorcoat layer, thus causing an undesirable color shift in the final coating. Accordingly, large amounts of basecoat or colorcoat must be applied over the adhesion promoter, primer or substrate layer to make a relatively thick, e.g. 25.4 to 50.8 μm thick, basecoat or colorcoat film provide adequate “hiding” or coverage or the substrate and/or any primer that is not of the desired color.

Owing to the cost of pigments, the basecoat or colorcoat is generally the most expensive layer in the painting of industrial substrates. Any need for large amounts of basecoat or colorcoat can drive up the costs of painting to the finisher of automotive parts, e.g. automotive trim. It would be desirable to reduce the total cost of color coating a metal or plastic substrate.

With the exception of some epoxy coatings for indoor decorative use, industrial coatings to date have relied on at least one primer or adhesion promoter layer to provide coating adhesion and durability. Accordingly, at present, nearly all of the installed coating equipment for automotive plastic and metallic substrates has been adapted to form coatings by a process comprising: Applying the adhesion promoter, which acts like a primer, or primer to the substrate; applying one or two basecoat or colorcoat layers; drying for a short time; and then applying any desired topcoat or clearcoat. However, the hiding power of a basecoat or colorcoat, especially with a lighter or brighter color basecoat, will often not be strong enough to cover the dark or drab color of the adhesion promoter/primer. Accordingly and at great expense, creating the desired color coating has meant applying additional basecoat or colorcoat layers to the first such layer. It would be desirable to provide effective hiding in a color coating process without requiring coatings applicators apply multiple basecoat or colorcoat layers.

Significant efforts have been made to solve the problem of providing effective hiding over a primer, including providing primers in modified colors that are typed or keyed to the basecoat color, e.g. by adding low amounts of the same pigment(s) that is/are used in the basecoat to the primer. However, primers have thus far comprised drab colored fillers and inorganic pigments to improve their surfacing and sandability properties and have included limited amounts of colorants in relatively low pigment/filler to binder ratios to insure adhesion properties. Accordingly, even the modified colors of the color “keyed” basecoats remain drab, presenting hiding problems, especially with lighter colors, e.g. whites or yellows, or bright colors, e.g. reds and oranges.

EP publication number 0148718 A2, to Panush, discloses a color tinted clear coat coating system comprising at least one basecoat and at least one topcoat layer and an optional primer layer, wherein the pigment in the topcoat and in the primer can be a pigment of the same color as the pigment in the base coat. However, the pigment-to-binder ratio in the topcoat and primer is present in an “amount less than” that ratio present in the base coat. As a result, separate pigment proportions, and often separate pigment mixtures, in each of the color tinted clear coat, basecoat and primer become critical to the aesthetics of the final color and the basecoat provides “less-than-hiding” color. Accordingly, the pigmentation of each layer of the base coat, primer coat and clear coat appears singular when evaluated for color; each layer contributes specific and separate aesthetics and hiding properties; and, the final color of the coating is a product of their unit. Further, any formulator for this system must provide unique coatings of for each layer of the coating, lest major total color deviations in the color of the product coating will result. As coating colors are matched by eye or with the aid of colorimetry in a labor intensive trial-and-error method, matching the desired color of two or three different specified colors to give a desired color combination amounts to an expensive and complex process. Finally, Panush never teaches or suggests color coatings that can hide dark grey or black substrates.

In accordance with the present invention, the present inventors have endeavored to limit the thickness or “film build” of the expensive basecoat to provide coatings having requisite hiding in two layers. Further, the present inventors have provided from a single color match weatherable industrial and automotive coatings that have a desired color. Still further, the present inventors have solved the aforementioned problems without requiring finishers to change the basecoat formulations that they currently use.

### SUMMARY OF THE INVENTION

The present invention provides coatings, preferably weatherable coatings, on plastic or metal substrates in two or more layers. The coatings comprise substrates coated with one or more than one colored primer layer(s) made from compositions comprising one or more than one pigment and one or more than one binder chosen from a resinous or (co)polymeric primer or adhesion promoter, and, coated over the colored primer layer(s), one or more than one basecoat color layer(s) made from compositions comprising one or more than one pigment and one or more than one (co)polymer or resin. The color of the basecoat layer and the color of the colored primer layer are the same, thereby improving hiding, and lowering the amount of the basecoat used without the need for separate color matching for each of a primer layer, a basecoat layer and any clearcoat applied thereto. As used herein, the term the “same” color may mean any color which appears to be the same when viewed by the naked eye as a color to which it is being compared, or any which measures, e.g. colorimetrically with a spectrophotometer or RGB camera, within a range of color change (ΔE) of 2.2 or less compared to one color standard, preferably 2.0 or less.

The coating may further comprise a clearcoat layer on the basecoat layer. Preferably, the coatings comprise one colored primer layer and one basecoat color layer, i.e. a total of two layers. More preferably, in the case of adhesion promoters, the colored primer layer(s) are free of any of the (co)polymer or resin found in the basecoat composition and the binders therein consist essentially of one or more adhesion promoters.

To improve hiding of substrates such as thermoplastic polyolefin (TPO) or polyolefin containing plastic substrates, which are generally dark grey or black, the pigment-to-binder ratio, by weight, (P/B) in one or more than one colored primer or adhesion promoter composition, referred to as (P/B_{A}), may be equal to or greater than the P/B in one or more than one basecoat color composition, referred to as (P/B_{B}). Generally, however, the ratio P/B_{A}/P/B_{B} may range from 0.75 or higher, preferably 0.99 or higher, or 1.0 or higher, and up to 5.0, or up to 2.5.

According to the present invention, compositions for making primer coating layers comprise highly durable adhesion promoter or primer resins or (co)polymers. Preferably, to improve adhesion to polyolefin containing or TPO substrates, the compositions for making the primer layer(s) comprise as a binder one or more adhesion promoter chosen from chlorinated polyolefin (CPO), modified isotactic polypropylene (MPP), MPP copolymers, MPP adducts, MPP copolymer adducts, and mixtures thereof. More preferably, the adhesion promoter is chosen from of MPP alkyd mixtures, MPP copolymer alkyd mixtures, CPO alkyd mixtures, CPO acrylic mixtures, MPP acrylic mixtures, and weatherable CPO, MPP or MPP copolymer adducts with acrylics, alkyds, urethanes or polyesters, and mixtures thereof to give weatherable primer layers.

In addition, the present invention provides a method of making a coating on a substrate, such as metal, TPO or polyolefin containing substrates. The method comprises applying to a substrate one or more than one colored primer or adhesion promoter composition comprising one or more than one pigment and one or more than one binder chosen from resinous or (co)polymeric primer or adhesion promoter to form one or more wet layer of primer; drying to form a colored primer layer; applying on the primer layer on the substrate one or more than one layer of colored basecoat composition comprising one or more (co)polymer or resin binder and one or more than one pigment; and, curing to form a basecoat layer and a cured color coating, wherein the color of the basecoat color layer and the color of the colored primer layer are the same. The method may further comprise applying one or more layer of a clearcoat composition wet on wet on the applied layer of colored basecoat prior to curing, and curing. Preferably, the method provides weatherable coatings

Preferably, methods to provide color coatings having excellent hiding properties comprise applying a single layer of each of the primer or adhesion promoter composition and of the colored basecoat composition to the substrate to make color coatings having a reduced film build. Accordingly, the ratio P/B_{A}/P/B_{B} in one or more composition used to make the respective colored primer and basecoat color layers of the color coating of the instant invention may range from 0.75 or higher when using adhesion promoters. The P/B_{A}/P/B_{B} may preferably range from 1.0 or higher when using primer binders or adhesion promoters, i.e. the P/B in one or more composition used to form a colored primer layer should be equal to or greater than the P/B in one or more composition used to form a basecoat color layer. More preferably, the colored adhesion promoter compositions used in the method of the present invention are free of any of the (co)polymer or resin used in the basecoat, i.e. the colored adhesion promoter composition comprises pigment and any optional ingredients, additives and fillers, and one or more than one binder consisting essentially of a resinous or (co)polymeric adhesion promoter.

### DETAILED DESCRIPTION OF THE INVENTION

The present invention provides coatings comprising at least one primer layer and at least one basecoat layer, wherein the primer composition gives the primer layer the same color as the color of the basecoat layer. Partial coverage of the black or dark substrate is achieved in the primer layer, resulting in better hiding of the substrate and improved color appearance in comparison to coatings made using drab colored primers. Less basecoat is used, thereby enabling automotive coatings to better compete on price with recently developed molded-in-color methods for making plastic parts. For example, excellent hiding can be obtained in a single basecoat application applied to a layer formed by a single primer or adhesion promoter application, thus giving a basecoat film thickness of from 10 to 24 μm, preferably from 13 to 21 μm, and a primer film thickness of from 5 to 12 μm, preferably from 7 to 11 μm. The coatings may comprise protective topcoats or clearcoats applied over the basecoat to give films ranging from 32 to 51 μm thick. In addition, the present invention also provides monocoat finishes consisting essentially of a primer layer and a basecoat layer comprising a weatherable (co)polymer or resin without any topcoat, thereby avoiding the expense of a protective clearcoat or topcoat.

Other advantages of the present invention include reduced paint spray and thereby reduced waste when making a coating film of the same quality, in comparison to coatings made by conventional methods. Further, the method of the present invention enables lower maintenance costs because fewer spray booths are needed in a single pass basecoat application, as compared a two-pass basecoat application, to give good hiding. The method may be used in waterborne (aqueous) or solvent borne coating compositions, powder coatings and combinations thereof.

All terminology that includes portions in parentheses denotes, alternatively, each of the term including the parenthetical portion and the term without such portion. For example, the term “(meth)acrylic” denotes each of methacrylic and acrylic in the alternative.

All ranges cited herein are inclusive and combinable. For example, if an ingredient may be present in amounts of 4 wt % or more, or 10 wt % or more, and may be present in amounts up to 25 wt %, then that ingredient may be present in amounts of 4 to 10 wt %, 4 to 25 wt % or 10 to 25 wt %.

Unless otherwise noted, all processes refer to and all examples were performed under conditions of standard temperature and pressure (STP).

Unless otherwise noted, to calculate the ratio P/B_{A}/P/B_{B}, calculate each of the P/B's of the primer composition and of the basecoat composition or calculate each of the P/B's of the primer film layer(s) and of the basecoat film layer(s). Layers are always compared to layers and compositions to compositions. When more than one primer composition is used, the P/B_{A} represents the average of all of the primer compositions; the same averaging is calculated when using more than one basecoat composition. Likewise, to calculate the P/B_{B} for multiple basecoat or primer layers, take the average of all of the P/Bs for each layer.

As used herein, the term “acrylic” includes both acrylic and methacrylic and the term “acrylate” includes both acrylate and methacrylate.

As used herein, the term “adhesion promoter” refers to a (co)polymer or resin used to coat a non-metallic substrate and “primer” refers to a composition or (co)polymer or resin used to coat a metallic substrate.

As used herein, the terms “basecoat”, “colorcoat” and “monocoat” refer to the same compositions, except that monocoats generally do not have clearcoats or topcoats layered there over.

As used herein, the “color” of a layer of a coating refers to the color of a dried, cured coating layer and the “color” of a coating composition refers to the color of the composition itself.

As used herein, the term “(co)polymer” means one or more polymer, one or more copolymer, or mixtures thereof.

As used herein, the term “copolymer” includes any of copolymers, terpolymers, and polymers polymerized from more than three different monomers or resins, as well as graft copolymers.

As used herein, the term “film thickness” refers to the average film thicknesses as determined by microscopic examination of at least three points along a 1 cm long cross-section of a coating film.

As used herein, the term “maleic” comprises either maleic acid or maleic anhydride independently of each other, unless otherwise indicated.

As used herein, the term “Mn” refers to number-average molecular weight, as determined by gel permeation chromatography (GPC).

As used herein, the term “MPP or MPP copolymer adduct” includes the reaction product of one or more polymer, resin or reactant, e.g. alkyd or acrylic or one or more having one or more hydroxyl, carboxyl, epoxy functional group, e.g. diol or hydroxyacid, with one or more than one carboxyl, anhydride, hydroxyl or epoxy functionality of one or more modified isotactic MPP or MPP copolymer. “Adducts” may also include the reaction product of one or more polymer or resin having a residual olefin functionality with of one or more isotactic MPP or MPP copolymer.

As used herein, unless otherwise indicated, the phrase “per hundred parts” resin or “phr” means the amount, by weight, of an ingredient per hundred parts, by weight, of the total amount of resin, reactant monomer, and polymer contained in a composition, including cross-linking resins and curing agents.

As used herein, the term “pigment” includes pigment, colorant and dye.

As used herein, the term “polymer” includes polymers, copolymers and terpolymers, and block copolymers and terpolymers.

As used herein, the phrase “plastic substrate” refers to TPO, a substrate comprising at least about 50 wt % of a resin which may be a propylene homopolymer or a copolymer in which at least 60 wt % of the monomer content is propylene.

As used herein, the term “shaped article” includes both plastic and metal molded articles, forged articles, such as coil springs, pressed articles, e.g. tablets, cast articles, e.g. brake shoes made by dewatering or removing solvent from suspensions, and multilayer films and laminates.

As used herein, the terms “topcoat” and “colorcoat” are interchangeable.

As used herein, the phrase “total solids” refers to the percentage of organic and inorganic solids, by weight, remaining after removal of volatile components, expressed as a portion of the total weight of a composition. As used herein, the term “TPO” refers to polypropylene containing compounds modified with rubber.

As used herein, the term “wt %” refers to weight %.

As used herein, the term “weight average molecular weight” refers to average polymer molecular weights as determined by gel permeation chromatography or by density gradient sedimentation methods.

Compositions for use in making the coatings according to the present invention and to be used according to the method of the present invention may be formulated into a variety of coatings and liquid film forming compositions. Such compositions include solventborne or aqueous compositions as primers or adhesion promoters, solventborne or aqueous compositions for use as basecoats, crosslinked basecoats, color coats, topcoats, and clear coats, and powder coatings for forming any of primer layers, basecoat layers, monocoat layers, topcoat layers, and clearcoat layers. Generally, topcoats and clearcoats comprise weatherable resins or (co)polymers and either comprise pigments or pigments in amounts that result in clear or translucent films, or lack pigments.

The compositions useful as primers or adhesion promoters in the present invention comprise one or more of each of (i) binders chosen from adhesion promoter or primer resins or (co)polymers, and (ii) colorants or pigments. The compositions useful as basecoats, monocoats or colorcoats, topcoats and clearcoats in the present invention comprise one or more of each of resins or (co)polymers, and colorants or pigments.

The one or more than one (co)polymer or resin useful in basecoats, colorcoats, topcoats and/or clearcoats include any of various thermoplastic and thermosetting (co)polymers or resins.

In aqueous compositions, useful (co)polymers or resins may comprise one or more polyolefins, acrylic polymers, acrylic modified alkyds, polyesters, polyamides, polyurethanes, blocked polyisocyanates, and their mixtures, grafts and copolymers, and, preferably, weatherable (co)polymers or resins. Aqueous dispersions may further comprise an anionic, a cationic or a non ionic aqueous dispersion formed with or without a dispersant, an emulsifier or a surfactant.

(Co)polymers or resins useful in the organic solvent borne compositions according to the present invention include alkyds, polyurethanes, polyesters, acrylics, acrylic modified alkyds, and mixtures and combinations thereof. Preferred solventborne (co)polymers or resins may include one or more higher molecular weight alkyds, polyurethanes, polyesters, acrylics and acrylic modified alkyds, each having low hydroxyl values of from 1 to 10 and low carboxyl values of from 1 to 10. The preferred polymers dissolve readily in organic solvents and yield films and coatings with good mechanical properties. More preferably, solvent borne coatings comprise weatherable (co)polymers or resins or blends.

“Weatherable” (co)polymers or resins or blends thereof for use in monocoats may be defined as any one or more (co)polymers or resins or blends which cure to form coatings or films in which less than 0.5 wt %, based on the weight of (co)polymer or resin solids in the film or coating, of residual epoxy groups; oxygen reactive functional groups, e.g. alkyd or acetoacetoxy; ultraviolet (UV)/visible radiation reactive functional groups, e.g. allyl or vinyl or acrylic, or water reactive functional groups, e.g. unblocked isocyanate. Weatherable coatings or films may contain less than 0.2 wt %, or less than 0.05 wt. %, or less than 0.02 wt % of such residual epoxy groups, oxygen reactive functional groups, ultraviolet (UV)/visible radiation reactive functional groups, or water reactive functional groups.

Suitable weatherable (co)polymers or resins in aqueous basecoat compositions may be chosen from two-component polyesters, e.g. carboxyl and hydroxyl functional components, two-component polyurethanes, e.g. isocyanate and hydroxyl functional components, polyester-melamines, acrylic-melamines, thermoplastic acrylics, one-component polyester, acrylic or polyurethane polyols mixed with blocked isocyanate crosslinkers, alkyd modified acrylics, and any one or more (co)polymers or resins useful in clearcoats and topcoats.

Suitable weatherable (co)polymers or resins for use in solvent borne applications comprise one or more two-component polyurethanes or polyesters, acrylic-melamines, polyester-melamines, one component polyesters, acrylics and polyurethane polyols mixed with blocked isocyanate crosslinkers, alkyd modified acrylics, and any one or more (co)polymers or resins useful in clearcoats and topcoats.

Preferred clearcoat and topcoat forming compositions may include curable epoxy functional materials for bug and sun resistance, and generally, include one or more polyurethanes, polyesters, acrylics and mixtures or combinations thereof for flexibility and weatherability.

The amount of copolymer or resin present in the basecoat, colorcoat, monocoat, topcoat or clearcoat compositions may range from 20 wt % or more, based on the total weight of the composition, or 30 wt % or more, to as much as 70 wt % or less, or 50 wt % or less, or 40 wt % or less.

In basecoat powder coatings according to the present invention, suitable (co)polymers or resins may comprise, for example, weatherable polyester epoxy hybrid thermosets, polyester resins mixed with triglycidyl isocyanurate (TGIC), β-hydroxyalkyl amide or polycarboxylic acid, e.g. dodecanoic acid, or anhydride curing agents, acrylic or urethane polymers, or hybrids and mixtures thereof. Proportions of (co)polymers and resins in basecoat powder coatings may range from 40 to 95 wt %, based on the total weight of the compositions.

Curing agents for any kind of coating composition may include those adapted to thermally cure at substrate surface temperatures below 150° C., preferably at or below 121° C. for plastic and below 105° C. for wood. These include, blocked catalysts or curing agents, the second component of any two-component system, e.g. melamine or isocyanate, imidazole-amine and epoxy-amine adducts for epoxy containing resins, e.g. powder coatings for wood.

According to the present invention, color matched primer or adhesion promoter compositions unexpectedly provide acceptable adhesion properties even when pigmented to such an extent that the color of the layer they provide matches the color of the basecoat layer applied on the primer or primer layer. To avoid dilution of the adhesion promoters, the preferred adhesion promoter compositions do not include basecoat (co)polymers or resins.

Suitable adhesion promoter (co)polymer binders for polyolefin-containing or TPO substrates may comprise chlorinated polyolefin (CPO), isotactic, low molecular weight, modified polypropylene (MPP), MPP adducts, isotactic, low molecular weight, modified poly (propylene-α-olefin) copolymer (MPP copolymer), MPP copolymer adducts, MPP alkyd mixtures, CPO alkyd mixtures, and mixtures and combinations thereof.

Preferably, the adhesion promoter binder comprises CPO, MPP, MPP copolymers or MPP adduct mixed with weatherable film-formers, such as alkyds, acrylics, alkyds, urethanes or polyesters. Alkyd mixtures or adducts with CPO, MPP, MPP copolymer or MPP adducts is especially preferred because it air-dries, suiting it to wet-on-wet application. The CPO-alkyd, MPP-alkyd or MPP copolymer alkyd mixture should have sufficient CPO to stick to the substrate, and thus comprises CPO in the amount of 5 wt % or more of total resin solids, or 8 wt % or more, preferably 10 wt % or more, and up to 40 wt %, preferably up to 25 wt %.

Suitable CPOs may be chlorinated amorphous and crystalline poly-α-olefins, optionally containing carboxyl groups. CPOs may comprise chlorinated propylene homopolymer or any propylene-α-olefin copolymer in which at least about 60 wt % of the monomer content is propylene. To provide proper film-forming properties, the carboxyl group containing poly-α-olefin may have a weight average molecular weight in the range of from 4,000 to 150,000, preferably, from 5,000 to 80,000, and, more preferably, from 25,000 to 50,000; the carboxyl group containing poly-α-olefin may have a softening point in the range of from 75° to 115° C., and an amount of chlorine in the range of from 10 to 35 wt percent, based on the weight of the polyolefin.

CPOs lacking carboxyl groups may be further modified, e.g. by grafting of an imide or with a monomer containing a carboxylic acid group or carboxylic acid anhydride group, e.g., maleic anhydride. If further modified with an imide, the imide may be present at between about 0.001 and about 10 wt % based on the weight of the polyolefin. If further modified with a monomer containing a carboxylic acid group or carboxylic acid anhydride group, the monomer may be present at between about 0.001 and about 10 wt % based on the weight of the polyolefin.

Examples of CPO may include chlorinated polyethylene or polypropylene or copolymers thereof with one or more α-olefin. CPO may be grafted with acrylic resin to make it more compatible with an acrylic containing basecoat or colorcoat and to make it more compatible with acrylic-containing substrates, like ABS.

Curing agents for acid or anhydride functional CPO or for acrylic grafted CPO may include melamines and isocyanates, as well as hydroxyl-functional acrylic resins. Curing agents may be used in amounts such that the stoichiometric ratio of the curing agent to the CPO ranges from 0.6:1.0 to 1.3 to 1:0. Such curing agents may be used for temperature sensitive plastic substrates.

Water dispersible CPO for waterborne coatings may comprise any of those polymers containing from 0 to 10 wt % of one or more than one unsaturated acid or anhydride, e.g. maleic anhydride, based on the weight of reactants used to make the polymer. Preferably, the water dispersible CPO can be partially or completely neutralized with ammonia, or, more preferably, with dimethyl-ethanolamine (DMEA) to render it partially water soluble.

MPP or MPP copolymers may be any polypropylene or poly (propylene-α-olefin) copolymer modified, for example, by oxidation, e.g. in the presence of an oxidizing agent, such as ozone, a peroxide, a perborate or a periodate compound, or by reaction with one or more than one unsaturated reactant containing one or more than one carboxyl, anhydride, hydroxyl or epoxy group, or combinations of those groups, such as maleic acid or anhydride, in the presence of an initiator. Preferably, the one or more than one isotactic, low molecular weight, MPP or MPP copolymer has one or two terminal olefin groups. The MPP or MPP copolymer may be modified at its one or two terminal olefin groups by reaction to form one or two terminal anhydride, carboxyl, hydroxyl or epoxy groups, preferably. The preferred terminally modified isotactic MPP or MPP copolymers give consistent dispersibility and adhesion properties in a variety of formulations and uses. Further, terminally modified MPP or MPP copolymers may be reacted with carboxyl or hydroxyl group containing acrylic polymer or resin to form an MPP or MPP copolymer-acrylic adduct that provides enhanced compatibility between acrylic basecoats and polyolefin containing or TPO substrates.

Low molecular weight isotactic polypropylene (PP) or PP copolymers that may be modified to form MPP or MPP copolymers may be any such (co)polymers having a number average molecular weight (Mn) of from 500 or more, as determined by GPC, for example from 800 or more, or from 1,000 or more. Further, such suitable PP or PP copolymers should have an Mn of up to 10,000, for example, up to 7,000, or up to 4,000, or up to 2,500. The melt viscosity of such (co)polymers may range from 20-300 cP @ 149° C.

Suitable PPs that may be modified have 90 wt % or less and 40 wt % or more, for example from 60 wt % or more of “isotacticity” or isotactic units, based on the total weight of monomeric units contained in the polymer. Suitable PP (co)polymers should have 9 wt % or more, for example 40 wt % or more, and 90 wt % or less, or 60 wt % or less, or 40 wt % or less of such isotactic propylene units. Highly isotactic (isotacticity ≦60 weight %) PP has a definite melting point and a surprisingly narrow molecular weight distribution. Such isotactic PP and PP copolymers have narrow molecular weight distributions and polydispersities of 1.5 to 3.0, for example 1.5 to 2.5, thereby providing coatings and films having controlled and predictable film forming and adhesion properties at predetermined temperatures, e.g. the melting point of the (co)polymer.

Suitable isotactic PP copolymers that may be modified may be random copolymers of not less than 10 weight % of propylene, based on the weight of the reactants used to make the copolymer, for example, not less than 40 weight %, with a higher α-olefin, i.e. having 3 to 12 carbon atoms, or a block copolymer of polypropylene with a poly(higher α-olefin). Examples of higher α-olefins include, butene-1, pentene-1, octene-1, and, preferably, hexene-1. Accordingly, isotactic PP copolymers for modification may be exemplified by isotactic modified propylene/hexane, isotactic propylene/butene, and isotactic propylene/butene/hexene copolymers, wherein each copolymer may have one or two terminal olefin groups. Mixtures of two or more of the higher α-olefins may be copolymerized with propylene.

Carboxyl and anhydride modifying groups may preferably be derived from reaction of the MPP or MPP copolymer with maleic acid or maleic anhydride groups, and can be derived from fumaric acid, itaconic acid, citraconic acid, allylsuccinic acid, mesaconic acid and aconitic acid, and their acid anhydrides. The amount of α,β-unsaturated dicarboxylic acid or its acid anhydride used may range from 1 wt % or more, based on the weight of the acid or anhydride modified copolymer, or 2 wt % or more, or 4 wt % or more, to 20 wt % or less, or 10 wt % or less, or 7 wt % or less, more preferably from 4 to 7 wt %. Other suitable isotactic MPP and MPP copolymers may be made by reacting the unsaturated group of an unsaturated carboxylic acid, anhydride, alcohol, diol, polyol or hydroxyacid onto an isotactic PP or PP copolymer. The preferred epoxy terminal isotactic MPP and MPP copolymer is available from the Baker Petrolite polymers division of Baker Hughes, Inc., Sugarland, Tex.

Suitable isotactic MPP or MPP copolymers may contain from 1 to 10, preferably 1 to 5, more preferably, one or two terminal carboxyl, anhydride, epoxy or hydroxyl groups per molecule. Isotactic MPP and MPP copolymers having 1 to 5 carboxyl, anhydride, hydroxyl or epoxy groups may be selected for their excellent solubility in xylene, toluene and other organic solvents; and those having from 2 to 10 carboxyl, anhydride, hydroxyl or epoxy groups may be selected for their water dispersibility.

By virtue of their melting point of 80° C. or higher, for example 105° C. or higher, and 145° C. or less, isotactic MPP or MPP copolymers may provide improved wet out and penetration of coatings, primers and film forming compositions of the present invention into TPO or polyolefin containing substrates, thereby improving the adhesion of coatings to these substrates at temperatures below which the substrate may be damaged by heat. The melting point of suitable isotactic MPP copolymers with an isotacticity of ≦60 wt %, based on the weight of the copolymer prior to being modified, ranges lower than the melting point of MPP homopolymers of the same Mn. Accordingly, isotactic MPP copolymers, particularly those with an Mn of 4,000 or less, may advantageously be used in low temperature cure applications, e.g. coatings for use on interior automotive plastics curing at 160 to 250° F. (71 to 121° C.), for example those curing at from 160 to 200° F. (71 to 93.3° C.).

In an alternative embodiment, primer compositions may comprise CPO in addition to isotactic MPP or MPP copolymer or adduct, preferably epoxy functional isotactic MPP or MPP copolymer or adduct which may act as a stabilizer for CPOs. These compositions may also comprise alkyd resins or adducts of alkyds. Such compositions contain reduced amounts of CPO and, thus, reduced amounts of chlorine. Solvent borne primer compositions may include up to 60 phr, preferably 0-40 phr, of CPO in addition to the isotactic MPP or MPP copolymer. Further, aqueous compositions may include up to 90 phr, preferably 0-60 phr, of CPO in addition to the isotactic MPP or MPP copolymer.

To provide added durability in and compatibility between films, layers or coatings, primer compositions in primer films, layers or coatings may be matched with certain basecoats or topcoats in the those other layers. For example, at least one (co)polymer or resin in at least one part thereof in the basecoat, colorcoat, monocoat, topcoat and/or clearcoat may be compatible with the polymer or resin, adhesion promoter or primer onto which the basecoat, colorcoat, monocoat, topcoat and/or clearcoat is coated.

Suitable matched compositions of primer binders and the basecoat polymers or resins with which they are used may include: Polyester-melamines or acrylic-melamines, used with one-component polyester-melamine or acrylic melamines; acrylic-isocyanates or polyester-isocyanates, used with two-component polyesters (carboxyl and hydroxyl components) or two-component acrylic-isocyanates; urethane lacquers in solvent systems, used with any urethane basecoat. Acrylic polymers or resins may include acrylated alkyds, thermoplastic acrylics and hydroxyl functional acrylics. Polyesters may preferably comprise hydroxyl functional polyesters, such as trimethylol propyl adipates. With the exception of urethane lacquers, which are used in solvent borne systems, any of the above binders may be used in aqueous or solvent borne liquid systems.

Suitably matched adhesion promoter compositions and basecoat compositions may include an acrylic-polyolefin blend or graft containing basecoat layer coated on a modified polyolefin containing primer layer.

Preferably, in the case of adhesion promoters, to avoid diluting the adhesion promoter, the composition for making the primer layer contains none of the basecoat polymer or resin. For example, a carboxylated isotactic polyethylene or a chlorinated polyethylene containing primer composition would not contain the polyethylene in the polyethylene-acrylic containing basecoat, though the compositions can form mutually compatible coatings or films.

The amount of binder (co)polymer or resin in the aqueous or solvent borne primer or adhesion promoter compositions, based on the total weight of the composition, ranges as high as 50 wt %, or as high as 40 wt %, preferably as high as 25 wt %, and should be present in the amount of no less than 5 wt % or more, or, preferably 15 wt % or more. may comprise 5 wt % or more, based on total solids, of the one or more primer or adhesion promoting polymer or resin, or may comprise 7 wt % or more, or 10 wt % or more. In powder coating compositions, the amount of binder (co)polymer or resin may range from 40 to 95 wt %, based on the total weight of the composition.

Useful pigments or colorants include, in liquid systems, any automotive grade organic or inorganic pigments. In powder systems, any pigment may be used.

Suitable pigments may include, for example, titanium dioxide, aluminum paste, mica, coated micas, phthalocyanine green, phthalocyanine blue-red, phthalocyanine red, phthalocyanine blue-green, phthalocyanine blue, phthalocyanine green-blue, phthalocyanine green-yellow, phthalocyanine green-extra yellow, copper phthalocyanine, indanthrene blue, chrome oxide green, azo yellow, indanthrone blue, cobalt blue, iron oxide blue, dinitriline orange, dianisidine orange, monoazo orange, molybdate orange, imidazole orange, perylene maroon-transparent, iron oxide red, yellow iron oxide, transparent red iron oxide, transparent yellow iron oxide, quinacridone red, quinacridone maroon, quinacridone gold, quinacridone magenta, quinacridone violet, toluidine red, perylene red, anthraquinone red, cadmium red, BON red, monoazo red, diketo-pyrrolopyrrole red, chromophtal red, carbazole violet, nickel titanate yellow, chrome titanate buff, chrome yellow, flavanthrone yellow, anthrapyrimidine yellow, isoindolinone yellow, metal chelated azo (copper, nickel, etc), carbon black, conductive carbon black, and thioindigo maroon.

The pigmentation of any primer or adhesion promoter, basecoat or colorcoat composition generally comprises one or more than one pigments, usually three or more, and may comprise inorganic and/or organic pigments. Generally, where the primer layer and the color or basecoat layers are of the same color, each of the compositions used to make them comprises the same pigment mix and may comprise the same weight amounts of pigment solids relative to binder solids, i.e. they may have the same P/B. To insure proper adhesion and film-forming properties in the coating and film-forming compositions, the total pigment relative to binder, by weight solids, (total P/B) for the total amount of inorganic metal oxides used in a composition, coating or film should range up to 1.63:1 for metal oxides, and should range up to 1.31:1 for total amounts of all other inorganic pigments or for organic pigments used.

Preferably, for certain pigments, the total P/B may range up to 0.65:1 for metal oxides; up to 0.26:1 for carbon black, preferably up to 0.10:1; up to 0.50:1 for aluminum or aluminum paste, or up to 0.26:1, or up to 0.13:1; and up to 0.39:1 for micas and coated micas. Preferably, the total P/B for organic pigments may range up to 0.20:1, and may be 0.01:1 or more. When mixtures of pigments are used, the total P/B for the two combined pigments may range up to 3.0:1 and should not be less than 0.04:1. Accordingly, if a mixture of titanium dioxide, cobalt oxide coated mica and perylene red were used, the total P/B for the combined pigments should range up 2.94:1, the total P/B for the two metal oxides in the composition should range up to 1.63:1 and the total P/B for the perylene red should range up to 1.31:1.

In lower solids compositions for forming color primer layers, the P/B for the colored primer or adhesion promoter composition (P/B_{A}) may range much higher than the P/B in the colored basecoat composition (P/B_{B}). The ratio P/B_{A}/P/B_{B} may range as high as 5.0, or as high as 3.0, or as high as 2.5. In the case of primer compositions, P/B_{A}/P/B_{B} generally is 1.0 or more, and in the case of adhesion promoter compositions, P/B_{A}/P/B_{B} generally is 0.75 or more.

Suitable liquid compositions comprise carriers and solvents and may, optionally, include anti-flocculants for color stability, and thixotropes, rheology modifiers or dispersants for coating stability and flow out.

In solventborne compositions, solvents, such as aromatic solvents, like xylene, toluene, aromatic distillates and their blends, and their mixtures; esters, such as isobutyl acetate, propylene glycol methyl ether acetate, isobutyl isobutyrate, and their mixtures; and ketones, such as methyl amyl ketone, may comprise up to 95 wt % of primer or adhesion promoter compositions, based on the total weight of the compositions, preferably up to 80 wt %, and, more preferably, up to 60 wt %, and, preferably, may be used in amounts of no less than 40 wt %, based on the total weight of the compositions.

Water and other carriers should be used in the same proportions in aqueous compositions as solvents are used in solventborne compositions. Co-solvents, such as n-methyl pyrrolidone and monobutyl ether of ethylene glycol may also be used in waterborne compositions. The total amount of water or carrier plus co-solvent should range in the same proportions in the waterborne compositions as does the proper total amount of water without co-solvent. Co-solvents may be added in the amount of up to 10 wt %, preferably up to 5 wt %, and may preferably be used in amounts of no less than 2 wt %.

One or more thixotropes, such as, for solvent borne compositions, dispersions of polyamide wax, fumed silica, and organophilic clay, such as trialkylarylammonium hectorite or smectite, or silicone dioxide dispersed in acrylic binders; and, for aqueous compositions, unmodified clays, e.g. hectorite or bentonite and cellulose ether and ester compositions may be added. Total amounts of thixotrope used to in the amount of from 0.01 to 5 wt % of the total weight of the composition, on a solids basis, preferably, from 0.1 to3 wt %.

In CPO and MPP-containing adhesion promoter compositions, antiflocculants, such as 10 wt % polysiloxane in cyclohexanone may be added in amounts of up to 3 wt %, based on the total weight of the composition, preferably, from 0.5 to 1.5 wt %.

In waterborne compositions, nonionic surfactants, e.g. nonylphenyl ether of poly(oxyethylene), and polyacrylic acid or alkali soluble polymer dispersants, may be added in the amount of from 0.1 to 1.0 wt %, based on the total weight of the compositions, preferably from 0.1 to 0.5 wt %.

In aqueous compositions, mineral spirits may be added as a defoamer.

Powder coating compositions may optionally comprise from 0 to 120 phr of fillers; catalysts such as thermal- and photo-initiators redox catalysts like cobalt octoate in the amount of from 0.1 to 1.0 phr; flow aids, such as thermoplastic alkyl (meth)acrylate copolymers in the amount of from 0.1 to 1.0 phr; dry flow additives, such as metal oxides like fume silica in the amount of from 0.1 to 1.0 phr to be used as a dry blend additive; and leveling agents such as silicone resins in the amount of from 0.1 to 1.0 phr.

Filler loadings of, e.g. from 10 to 120 phr, may be used in powder coating compositions. For example, corrosion resistant zinc rich powder coatings useful as primers may comprise one or more than one isotactic MPP or MPP copolymer or adduct and from 25 to 120 phr of zinc. The same proportion of zinc can be mixed into basecoat powder coatings. The exemplary primer powder coatings may be applied directly to untreated steel or to TPO or polyolefin-containing substrates followed by any color matched basecoat, liquid or powder, to give a corrosion resistant finish. In another example, textured finishes may be formed by adding from 10 to 120 phr of wollastonite, silicate or calcium carbonate fillers.

All ingredients for powder coatings should be in solid form. Liquids such as several of the organic colorants and pigments and any liquid resins may be absorbed onto a solid carrier, e.g. silica, for use in powder coatings. Preferably, powder coating compositions comprise resins or (co)polymers that do not soften, melt or flow at temperatures below 40° C.

Any of the compositions used in the present invention, e.g. primer or basecoat or clearcoat may be made via conventional methods, for example, by adding the components in any order to a mixing vessel while agitating them at high speed or high shear in a dissolver. To aid in dissolution, the ingredients may be mixed at temperatures of at least 5° C., preferably, 22° C. or more, and as high as 44° C., preferably as high as 28° C. Powder coatings may be made, for example, by melt-mixing or extrusion of the ingredients, followed by cooling, grinding to a powder and mixing in dry blend additives.

The coating methods of the instant invention may be applied using any conventional coating application equipment, such as electrostatic and pneumatic spray equipment, such as electrostatic or pneumatic spray guns or electrostatic bells. Powder coatings may be applied using any electrostatic applicator and may also be applied using any fluidized bed or magnetic brush.

Coating compositions may be applied, for example, in a two-booth (primer and then basecoat) or three-booth (primer-basecoat-basecoat) wet-on-wet application coating system. In addition, one or more adhesion promoter or primer circulating systems may preferably be added to the first or primer booth. The circulating systems run adhesion promoter or primer supply lines through a “paint kitchen” that controls ingredients for all, e.g. 10 to 50, different colors used, and allows delivery of different colors to the same applicator device, e.g. a spray gun. The circulating system allows the elimination of a second basecoat paint booth by enabling automated color matching of the adhesion promoter or primer composition to the basecoat or colorcoat composition in any color.

Coating compositions may be cured via air drying, optionally with heat, via thermal cure, e.g. in an infrared or convection oven, via ultraviolet (UV) cure, or via any combination thereof. By using a wet-on-wet system, only one cure need be effected after all layers have been applied. When using two-component compositions, heat curing should be continued until all of the second component has been cured. Baking or heat curing should be carried out at temperatures prescribed to avoid damaging heat sensitive substrates and compositions should be selected so as to enable curing at such temperatures. Plastics should not be heated above a surface temperature of 121° C. Brass cannot withstand surface temperatures above 177° C. Wood should not exceed a surface temperature of 105° C. Exemplary coating compositions for low temperature cure include alkyd-air drying coatings, UV curable resins such as unsaturated polyesters or acrylics, two-component compositions, one-component compositions comprising blocked catalysts (e.g. blocked isocyanates or blocked acids) and compositions containing curing agents adapted to cure at the above-mentioned temperatures.

Coating, primer and adhesion promoter compositions may advantageously be applied to metals, such as any industrial metal substrate made of aluminum, e.g. extruded profiles for windows, iron, steel, e.g. beams and girders, zinc, brass, copper, molybdenum or titanium, and any alloy or mixture thereof. Powder coatings may advantageously be applied to wood, plywood, fiberboard and paneling. Additionally, the compositions may be applied to plastic substrates. Suitable plastic substrates may include, for example, polyolefin, nylon, polybutylene terephthalate, acrylonitrile-butadiene-styrene (ABS), and any sheet molded composites (SMC).

Preferably, in coating plastic substrates, at least a comonomer or starting material component of the primer or adhesion promoter binder is compatible with or the same as the substrate onto which it is coated. For example, acrylic-melamine primers would be preferable for acrylonitrile-butadiene-styrene (ABS) substrates, with acrylic-co-styrene-melamine primers even more preferred; likewise, polyolefin containing adhesion promoters are preferred for polyolefin containing substrates.

The aqueous, solvent borne and powder primer or adhesion promoter compositions may be applied directly to interior and exterior automotive parts, such as those containing TPO or polyolefin, auto parts and industrial parts containing ABS resins, e.g. brake parts, and SMCs for any purpose, e.g. roof panels, kitchen and bath fixtures, or skis. Interior automotive substrates may include, but are not limited to, dashboards, switches and knobs, interior moldings and panels, e.g. door panels, upholstery and airbags. Exterior automotive substrates may include the body, bumpers, cladding and exterior trim, as well as under hood and underbody. When used on interior automotive substrates the coatings, primers and film forming compositions according to the present invention may comprise low bake (e.g. 160° F. to 250° F. or 71° C. to 121° C.) compositions so as not to damage temperature sensitive substrates.

Alternatively, any coating compositions may be used as molding, film forming, and shaped article forming compositions, e.g. for laminate and decalcomania, or may be used in making storage stable batches which can be added to liquid coating and film forming compositions.

In the following examples, some or all of the following test methods were performed:

1. Film builds of basecoat and primer were tested using ASTM method D-1005-51 (June 1979), “Measurement of Film Thickness of Organic Coatings”. A Bausch and Lomb Microzoom II microscope was used to read film builds. The microscope has been routinely calibrated at 6 month intervals. The film build readings were measured in mils (1 mil equals 25.4 μm).

2. Adhesion (cross-hatch adhesion) of coatings to substrates was tested using ASTM method D-2197-68, (October 1981), “Adhesion of Organic Coatings”. Results were expressed in % adhesion retention to the substrate, based on total coating area.

3. Humidity resistance was tested at 100° F. (38° C.) in an Atlas SF850 relative humidity chamber using ASTM method D-2247-02, (August 2002), “Water Resistance of Coatings in 100% Relative Humidity”. The humidity cabinet has routinely been calibrated at 6 month intervals. Panels were exposed for a period of 96 hrs. and evaluated for % adhesion retention, based on total coating area.

4. The colors of the adhesion promoter/basecoat systems were measured using an X-Rite MA6811 multi-angle spectrophotometer, routinely calibrated every 6 months, to give colorimetric color readings. Color properties were measured at three angles (25°, 45°, and 75°) and compared against stored colorimetric computer standards of control basecoat systems. Results were expressed in terms of ΔE, a change in units of color from the control. Generally, a reading of ≦2 units is considered to be acceptable color, but a color can also be deemed acceptable with units slightly higher than 2 if found to visually match the color standard. The coatings were sprayed at thicknesses of 10 to 20 microns on a 4″×6″ (101.6 mm×152.4 mm) plaque of thermoplastic olefin substrate, CA186 from Basell Polyolefins, Lansing, Mich.

### EXAMPLES

### Color Coating of TPO Substrates

An adhesion promoter resin intermediate, shown in TABLE 1 was formulated by mixing the components together in a laboratory vessel using moderate agitation with a Cowles blade and an air mixer under ambient conditions.

In Examples 1, 2, 3 and 4, tabulated below, the colored adhesion promoter formulations listed below were prepared in the laboratory utilizing an air mixer under ambient conditions (˜25° C.). The pigment dispersions, aluminum and mica pigment blends were added while mixing and dispersed with a laboratory size Cowles blade mixer under low shear of from 500 to 700 RPM. Each colored adhesion promoter was agitated for 30-45 minutes after the last component was added. Each prepared colored adhesion promoter was then sprayed using a Binks Model 95 spray gun supplied with compressed air over 4″×12″ (101.6 mm×152.4 mm) panels made of a dark grey TPO substrate. Air atomization was set at 60 psi and the targeted primer layer dry film thickness was set at 10 to 20 μm. Using the Binks Model 95 spray gun supplied with compressed air, each of the colored adhesion promoter layer treated panels was then topcoated with a 1-component (polyester/melamine) automotive basecoat of the exact same color as the colored adhesion promoter to completely hide the substrate. Air atomization was set at 60 psi. After a 5 minute ambient flash, a 1-component (acrylic melamine) automotive clearcoat was applied over the colored basecoat with a Binks Model 95 spray gun supplied with compressed air. Air atomization was set at 60 psi and the targeted clearcoat dry film thickness was 37.5 to 44.5 μm. The thus coated panels were cured for 30 minutes at 250° F. (121° C.) in a Blue M Electric Laboratory Oven and then tested.

The phrase “NVM” refers to wt % of non-volatile materials.

TABLE 1
Adhesion Promoter Resin Intermediate:

| | Percentage |
|---|---|
| COMPONENT | by weight |
| Styrenated Alkyd resin (50 wt % solids in xylene) | 11.91 |
| Chlorinated Polyolefin Intermediate (15 wt % solids in a | 14.23 |
| mix of 54.3 wt % xylene, 25.7 wt % cyclohexane, and 5 wt % | |
| cyclohexanone) | |
| Xylene | 31.63 |
| Toluene | 9.88 |
| Aromatic 100 (blend of aromatics and aliphatic petroleum | 16.29 |
| distillates, Ashland Distributors, Columbus, OH) | |
| Aromatic 150 (blend of aromatics and aliphatic petroleum | 2.89 |
| distillates, Ashland Distributors, Columbus, OH) | |
| Cyclohexane | 3.66 |
| Cyclohexanone | 3.60 |
| Isobutyl Isobutyrate | 1.00 |
| Thixotrope Dispersion (4 wt % solids amide wax, in a | 3.95 |
| mixture of 80 wt % toluene, 20 wt % xylene, 1 wt % | |
| methanol, 2 wt % ethanol, 0.12 wt % ethyl acetate, 2.5 | |
| wt % ethylbenzene, .02% MIBK) | |

EXAMPLE 1
Color: Arizona Beige Adhesion Promoter

| | Percentage |
|---|---|
| COMPONENT | by Weight |
| Adhesion Promoter Resin Intermediate | 93.66 |
| Add under low agitation | |
| Aluminum Pigment | 3.24 |
| Transparent Red Iron Oxide Dispersion (63.08% NVM: 37.55 | 0.93 |
| wt % Binder and 25.33 wt % Pigment) | |
| Carbon Black Dispersion (35.80% NVM: 30.74 wt % Binder | 1.71 |
| and 5.06 wt % Pigment) | |
| Titanium Oxide Dispersion (61.56% NVM: 41.41 wt % binder | 0.46 |
| and 20.15 wt % Pigment) | |

EXAMPLE 2
Color: Arrival Blue Adhesion Promoter

| | Percentage |
|---|---|
| COMPONENT | by Weight |
| Adhesion Promoter Resin Intermediate | 91.74 |
| Add under low agitation | |
| Carbon Black Dispersion (41.53% NVM: 29.14 wt % Acrylic | 0.56 |
| Binder and 12 wt % Pigment) | |
| Phthalocyanine Blue Dispersion (46.85% NVM: 26.79 wt % | 1.93 |
| Resin Binder and 20.06 wt % Pigment) | |
| Phthalocyanine Blue Dispersion (39.97% NVM: 30.92 wt % | 3.85 |
| Acrylic Binder and 9.06 wt % Pigment | |
| Red oxide Coated Mica (100% NVM) | 0.96 |
| Blue oxide Coated Mica (100% NVM) | 0.96 |
| Aluminum Pigment | 1.00 |

EXAMPLE 3
Color: Medium Green Pearl Adhesion Promoter

| | Percentage |
|---|---|
| COMPONENT | By Weight |
| Adhesion Promoter Resin Intermediate | 94.55 |
| Add under low agitation | |
| Carbon Black Dispersion (41.53% NVM: 29.47 wt % | 1.01 |
| Binder and 12.04 wt % Pigment) | |
| Phthalocyanine Green Dispersion (50.18% NVM: | 1.73 |
| 25.12 wt % Binder and 25.06 wt % Pigment) | |
| Transparent Yellow Oxide Dispersion (63.00% | 1.23 |
| NVM: 35.70 wt % Binder and 27.30 wt % Pigment) | |
| Coated Green Mica (100% NVM) | 1.48 |

EXAMPLE 4
Color: Sport Red Adhesion Promoter

| | Percentage |
|---|---|
| COMPONENT | By Weight |
| Adhesion Promoter Resin Intermediate | 90.29 |
| Add under low agitation | |
| Carbon Black Dispersion (41.53% NVM: 29.47 wt % | 0.37 |
| Binder and 12.06 wt % Pigment) | |
| Perylene Red Dispersion (50.59% NVM: 30.59 wt % | 2.80 |
| Binder and 20.00 wt % Pigment) | |
| Magenta Dispersion (47.34% NVM: 27.28 wt % | 3.74 |
| Binder and 20.06% Pigment) | |
| Red Oxide Coated Mica (100% NVM) | 1.40 |
| Russett Oxide Coated Mica (100% NVM) | 1.40 |

TABLE 2
Pigment to Binder Weight Ratios in the Primer
Layer (P/B_{A}) and in the Basecoat Layer (P/B_{B})

| EXAMPLE - | | | |
|---|---|---|---|
| COLOR | Total P/B_{A} | Total P/B_{B} | P/B_{A}/P/B_{B} |
| 1 - Arizona Beige | 0.418 | 0.146 | 2.863 |
| 2 - Arrival Blue | 0.398 | 0.253 | 1.573 |
| 3 - Medium Green | 0.267 | 0.119 | 2.244 |
| Pearl | | | |
| 4 - Sport Red | 0.444 | 0.243 | 1.827 |

TABLE 3
TEST RESULTS

| COLOR COAT | | | ΔE | | |
|---|---|---|---|---|---|
| (Adhesion Promoter Topcoated | | % ADHESION | (Compared to color | | |
| with Automotive Basecoat | % INITIAL | RETENTION AFTER | standard at three | | |
| Color and Clearcoat) | ADHESION | 96 HOURS HUMIDITY | viewing angles) | | |
| Example - Color | RETENTION | EXPOSURE (38° C.) | 25° | 45° | 75° |
| 1 - Arizona Beige | 100 | 100 | 0.58 | 2.31 | 2.05 |
| 2 - Arrival Blue | 100 | 100 | 1.19 | 0.70 | 1.38 |
| 3 - Medium Green Pearl | 100 | 100 | 1.48 | 0.37 | 0.21 |
| 4 - Sport Red | 100 | 100 | .55 | .82 | 1.18 |

As shown in Table 3, a range of color standards has been faithfully matched and reproduced in a variety of colors. In addition, even with a relatively high total pigment loading in the adhesion promoter composition, as shown by the P/B_{A}/P/B_{B} in Table 2, the inventive coatings exhibited excellent adhesion to a TPO substrate and did so even the case of the light color, Arizona Beige.

We claim:

1. A coating in two or more layers comprising a substrate having coated thereon one or more than one colored primer layer made from a composition comprising one or more than one pigment and one or more than one binder chosen from a resinous or (co)polymeric primer or adhesion promoter; and,
on the said one or more than one colored primer layer, one or more than one basecoat color layer made from a composition comprising one or more than one pigment and one or more than one (co)polymer or resin and,
wherein the said color of the said one or more than one basecoat color layer and the said color of the said one or more than one colored primer layer are each the same, and,
further wherein, the total pigment-to-binder ratio, by weight, (total P/B) in the said composition for making one or more of the said colored primer layer(s) (P/B_{A}) is equal to or greater than the total P/B in the said composition for making one or more of the said basecoat color layer(s) (P/B_{B}).

2. A coating as claimed in claim 1, further comprising a clearcoat layer on the said one or more than one basecoat color layer.

3. A coating as claimed in claim 1, wherein the said substrate comprises plastic or metal.

4. A coating as claimed in claim 3, wherein the said substrate is plastic and comprises thermoplastic polyolefin (TPO).

5. A coating as claimed in claim 1, wherein the said resinous or (co)polymeric primer or adhesion promoter is chosen from a chlorinated polyolefin (CPO), a modified isotactic polypropylene (MPP), a MPP copolymer, an MPP adduct, an MPP copolymer adduct, MPP alkyd mixtures, MPP copolymer alkyd mixtures, CPO alkyd mixtures, CPO acrylic mixtures, MPP acrylic mixtures, and mixtures thereof.

6. A coating in two or more layers comprising a substrate having coated thereon one or more than one colored primer layer made from a composition comprising one or more than one pigment and one or more than one binder chosen from a resinous or (co)polymeric adhesion promoter chosen from a chlorinated polyolefin (CPO), a modified isotactic polypropylene (MPP), a MPP copolymer, an MPP adduct, an MPP copolymer adduct, MPP alkyd mixtures, MPP copolymer alkyd mixtures, CPO alkyd mixtures, CPO acrylic mixtures, MPP acrylic mixtures, weatherable CPO adducts, weatherable MPP adducts, and mixtures thereof; and,
on the said one or more than one colored primer layer, one or more than one basecoat color layer made from a composition comprising one or more than one pigment and one or more than one (co)polymer or resin and,
wherein the said color of the said one or more than one basecoat color layer and the said color of the said one or more than one colored primer layer are each the same.

7. A coating as claimed in claim 6, wherein the said adhesion promoter is chosen from MPP alkyd mixtures, MPP copolymer alkyd mixtures, CPO alkyd mixtures, CPO acrylic mixtures, MPP acrylic mixtures, weatherable CPO adducts with acrylics, weatherable CPO adducts with alkyds, weatherable CPO adducts with urethanes, weatherable CPO adducts with polyesters, weatherable MPP adducts with acrylics, weatherable MPP adducts with alkyds, weatherable MPP adducts with urethanes, weatherable MPP adducts with polyesters, and mixtures thereof.

8. A method of making a coating comprising:
applying to a substrate one or more than one colored primer or adhesion promoter composition, the said composition comprising one or more than one pigment and one or more than one binder chosen from a resinous or (co)polymeric primer or adhesion promoter, thereby forming a wet layer of primer;
drying to form a colored primer layer;
applying on the said primer layer on the said substrate one or more than one layer of colored basecoat composition comprising one or more (co)polymer or resin binder and one or more than one pigment; and
curing to form a basecoat color layer and a cured color coating,
wherein the said color of the said basecoat color layer and the said color of the said colored primer layer are the same, and,
further wherein, the total pigment-to-binder ratio, by weight, (total P/B) in one or more of the said colored primer or adhesion promoter composition (P/B_{A}) is equal to or greater than the total P/B in one or more of the said colored basecoat composition (P/B_{B}).

9. A method as claimed in claim 8, further comprising
applying one or more layer of a clearcoat composition wet on wet on the said one or more than one layer of colored basecoat prior to said curing.

10. A weatherable coating made from the method as claimed in claim 8.
